(19) United States
(12) Patent Application Publication
(10) Pub. No.: US 2019/0229921 A1
(43) Pub. Date: Jul. 25, 2019

(54) Private Multi-Secret Cryptographic Transaction System

(71) Applicant: Allen Pulsifer, Annapolis, MD (US)

(72) Inventor: Allen Pulsifer, Annapolis, MD (US)

(21) Appl. No.: 16/254,035

(22) Filed: Jan. 22, 2019

Related U.S. Application Data
(60) Provisional application No. 62/620,353, filed on Jan. 22, 2018.

(51) Int. Cl. H04L 9/32; H04L 9/08

(52) U.S. Cl. CPC H04L 9/3221; H04L 2209/56; H04L 2209/16; H04L 9/0861

(57) ABSTRACT

This invention is in the field of private cryptographic transactions and discloses a method to create completely private “multi-signature” transactions using a private or “zero knowledge” proving system. The method includes multiple provers, each of which create one or more proofs with completely private hidden inputs. The proofs may require that a private value must be the same in more than one proof. The invention discloses a method of ensuring this by encrypting the private input and using this as a public input to the proofs.

### FIELD OF INVENTION

This invention discloses a method to add completely private “multi-signature” transactions to a cryptographic transaction system.

### PRIOR ART

Bitcoin was the first successful cryptographic currency. In Bitcoin, transactions are authenticated using digital signatures, where a signature can be created using a secret signing key (“private key”), and then verified by any other participant using a public signature verification key (“public key”). The private key and corresponding public keys are together known as a key pair. A token can be created that is associated with a single public key, and to subsequently spend the token, the spend transaction must be signed with the corresponding private key. If the spend transaction is not signed by the corresponding private key, the transaction is rejected by the other network participants. A token can also be created that is associated with multiple public keys, which in the literature is known as a multi-signature or multisig token, and transactions spending these tokens are known as multi-signature or multisig transactions. In Bitcoin, a multisig token is also associated with a computer-executable script that determines the signature requirements to spend the token. A script may for example require only a single signature that corresponds to any of the public keys, two signatures that correspond to any two different public keys, three signatures, or signatures corresponding to all of the keys. If there are N different public keys and the script requires signatures corresponding to M or more different keys, then this is called an M-of-N signature requirement. In general, each of the N private keys is known by only one person, and therefore the M signatures that correspond to M different secret keys are equivalent to the signatures of M different people. In some applications however, a single person may know more than one of the secret keys, and the correspondence between different keys and different persons may not hold. Some applications of multisig transactions include: a 2-of-2 signature requirement where both a company President and Treasurer must agree on the disbursement of funds; a 3-of-5 signature requirement where a majority of five trustees must agree on the disbursement of funds; and a 2-of-3 signature requirement for funds placed in escrow where the buyer and seller may jointly close out the escrow if they both agree, or they may enlist the aid of the escrow agent who can jointly act with either party to disburse the funds.

A major shortcoming of the Bitcoin system is a lack of privacy. In Bitcoin, a cryptographic hash of the spend script is publicly published when a token is created, and then the script itself, the public keys and the transaction signatures are publicly published when the token is spent. This allows the public to easily distinguish single-signature and multi-signature transactions and thereby gain some insight into the source and purpose of the transaction.

International Patent Application number PCT/US16/60673 disclosed a method of creating a private transaction based on a zero knowledge proving system. For each transaction, the zero knowledge proving system involves one prover and one or more verifiers. The system allows the prover to prove that she knows one or more hidden values known only to herself that, when combined with one or more public values known to all parties, satisfy an agreed upon set of constraints. In the '0673 invention, a token is associated with a secret, a value or amount, and a commitment=zkhash(secret, value) where zkhash is a cryptographic hash function. The commitment is published to a broadcast network, and all participants enter the commitment into a Merkle tree of all valid commitments. In order to spend tokens, a transaction message is created that contains the serial numbers for one or more tokens and a zero knowledge proof that the sum of the transaction input token values equals the sum of the transaction output token value and, for each input token: (a) serial number=zkhash(secret, commitment); (b) the commitment value=zkhash(secret, value) is in the Merkle tree of all valid commitments; (c) that the creator of the zero knowledge proof knows the secret. The serial numbers, zero knowledge proof and Merkle tree root are published with the transaction while the remaining quantities are used only as hidden inputs to the zero knowledge proof. The transaction is broadcast through a network which allows any other participant to verify that the serial numbers have not been used in a prior transaction and that all of the above properties hold without revealing the hidden inputs. Publishing only commitments when creating a token, and publishing only serial numbers when spending a token keeps the relationship between the transaction inputs and outputs private, and the token amounts are kept private by being used only as hidden inputs in the zero knowledge proving system.

The '0673 application also disclosed a hierarchy of secrets which included, from top to bottom: a master_secret that can be stored on an air-gapped host and used to spend frozen tokens; a root_secret from which one or more secrets lower in the hierarchy can be derived; one or more spend_secrets that can be required to spend tokens but are not sufficient to spend frozen tokens; one or more monitor_secrets that can be used to monitor the blockchain for incoming payments and could be used to create a transaction that freezes a token; and one or more receive_secrets that can be used to compute token destinations. The secrets lower in the hierarchy are derived from a secret at the next higher level through the zkhash function which allows the relationship to be proven in a zero knowledge proof.

While this hierarchy of secrets provides the capability to have multiple secrets with differing levels of capability or privilege, it does not provide the ability to have multiple secrets with the same level of capability that can be used in M-of-N type multisig transactions. Within the framework of the '0673 invention, M-of-N type multisig transactions could be provided using a system nearly identical to the Bitcoin: each token could be associated with a script and one or more public signature keys, and with the script, public keys and signatures provided with the spend transaction so they can be verified by all other participants in the system. The disadvantage of this system is that the multisig transactions would still be easily distinguished from single signature transactions. It is desired to have a multisig-type method that is completely private, i.e., where all transactions are publicly indistinguishable so that a person who is not a party to a transaction would be unable to determine how many signatures were allowed by, required by, or used in the transaction. This invention accomplishes that by allowing multiple spend secrets to be used inside a zero knowledge proof, such that existence and use of the multiple secrets is completely private.

Another shortcoming in the current state of the art is that tokens can become permanently unspendable if a token owner passes away, is incapacitated, or loses a secret. One solution would be to give one or more third parties such as executors or trustees copies of the secrets needed to spend the token. However, this approach would allow the third parties to use the secrets to steal or misuse the token. It is desired to create a solution that does not have this disadvantage. This invention addresses this problem by implementing two sets of multisig-type secrets, where the first set of multisig secrets is referred to as more privileged, and the second set as less privileged. Both sets of secrets can independently be used to spend the token, but a transaction that uses the less privileged secrets would be delayed, and could be overruled during the delay period by a subsequent transaction that uses the more privileged secrets. More specifically, when the more privileged secrets are used in a transaction to spend a token, the transaction would become effective immediately or after some time period chosen by the creators of the token, the creators of the transaction, or as determined by the system. When the less privileged secrets are used to spend the token, the transaction would not take effect until a relatively long delay after the transaction is added to a blockchain, which might be as long as 6 to 12 months. This delay might be determined by the system, or might be chosen by the creators of the token. During this delay, a transaction using the less privileged secrets could be overruled by creating a transaction that uses the more privileged secrets, in which case the transaction using the more privileged secrets would take effect immediately or after some period of time, and the prior transaction using the less privileged secrets would have no effect. The total number of less privileged secrets may be more, less or the same as the total number of more privileged secrets, and the number of less privileged secrets needed to spend the token may be more, less or the same as the number of more privileged secrets needed to spend the token. The intention is that the more privileged secrets would be held by the token owners, while the less privileged secrets may be stored offline or given to one or more executors/trustees who could act for the token owners in the event one or more token owners are unable to act. The less privileged secrets could be used by the executor/trustees (or by the token owners themselves in the event a more privileged secret is lost) to create a transaction that takes effect after the relatively long delay. Meanwhile, the token owners could continually or periodically monitor the blockchain, and if they detected a transaction that would spend the token after the relatively long delay, and if they did not approve of this transaction, they would have an opportunity to overrule this transaction during the delay period by creating a new transaction that uses their more privileged secrets. Thus, the executors or trustees or any persons holding the less privileged secrets would have the ability to spend the token after a delay, but if the owners were able to act using the more privileged secrets, they could retain control of the token by overruling the use of the less privileged secrets. This allows the token to remain under the control of the token owners even though the less privileged secrets might be stolen or misused, while providing a secondary ability to spend the token if a more privileged secret is lost or one of the holders of the more privileged secrets is unable to act.

### DESCRIPTION OF DRAWINGS

FIG. 1 depicts the possible hierarchy of multi-secrets, including the more privileged multi-secrets called spend_secret's, and the less privileged multi-secrets called trust_secret's. For purposes of illustration, the number of secrets is shown as three, although a particular instantiation may have more or fewer.

FIGS. 2 through 10 depict the statements enforced by the zero knowledge proofs. In these drawings, a thick-lined rectangle represents a publicly published input to the proof; a thick-lined diamond represents a private or hidden input to the proof; a thin-lined diamond represents a computed value; a thin-lined circle represents a computation or mathematical relationship, and a thick-lined circle represents a constraint that is enforced and proven by the proof FIG. 2 depicts part of the proof statements for each transaction output token in both of the embodiments described below. FIG. 3 depicts part of the proof statements for each transaction input token in both of the embodiments described below. FIGS. 4, 5 and 6 depict part of the remaining proof statements for each transaction input token in the first embodiment described below. FIGS. 9 and 10 depict part of the remaining proof statements for each transaction input token in the alternative embodiment described below, and FIGS. 7 and 8 depict part of the remaining proof statements for each set of secrets of each transaction input token in the alternative embodiment.

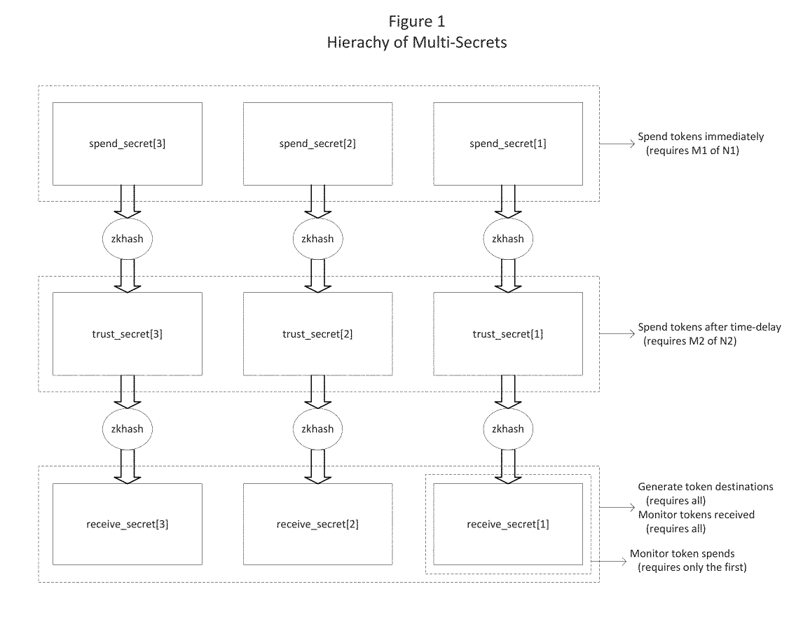

### DETAILED DESCRIPTION OF THE PREFERRED EMBODIMENTS

The transaction protocol in the preferred embodiment operates as follows:

1. A zero knowledge proving system using Pinocchio or a similar system is set up to enforce the constraints given below for transactions with a multi-signature capacity (the maximum number of signatures desired for one token) of Q, and with varying numbers of input and output tokens, including a transaction with at least two input tokens and at least two output tokens, or alternately, a transaction with at least one input token and at least two output tokens and a transaction with at least two input tokens and at least one output token. In the preferred embodiment, it is desired that all transactions be indistinguishable, and therefore a zero knowledge proof would be set up for only one transaction type with two input tokens, two output tokens, and the maximum allowed number of signatures Q. As described in prior art, token value can be split and merged as desired by using a series of transactions each with two input tokens and two output tokens.

2. To initiate a transaction, the Payor determines the number of tokens she wishes to create as outputs of the transaction and the value of each token. The number of tokens created must be no more than the maximum number of output tokens allowed by the largest capacity zero knowledge proof. One of the output tokens may be reserved to send “change” back to the Payor.

3. For each output token, the Payee, or each of the parties that will participate in a multi-signature token (the Payees), generates one or more random or pseudo-random 256 bit spend_secret's. The spend_secrets may be derived from a master_secret and spend_secret_number as described in the '0673 application. The total number of spend_secrets N for an output token must be less than or equal to Q.

4. For each spend_secret, the respective Payee computes:

trust_secret=zkhash_C(spend_secret)

receive_secret=zkhash_D(trust_secret)

5. The Payees or a designee of the Payees organizes the receive secret's into an array of N elements, receive_secret[1], . . . , receive_secret[N], where N can have a different value for each output token. If N for an output token is less than Q, the Payor adds to the array Q minus N additional receive secret's, receive secret[N+1], . . . , receive_secret[Q]. The additional receive_secret's may be known constants such as receive_secret=0 or receive_secret=zkhash_D(0). In the former form, it is assumed that a pre-hash of 0 (i.e., a value Z that satisfies zkhash_D(Z)=0) is unknown and can never be found; the safer and preferred embodiment however is to use receive_secret=zkhash_D(0), so that the pre-hashes of the additional receive_secret's are known by all parties.

6. For each receive_secret[i], the Payees or a designee choose a boolean value for use_spend_secret[i]. If use_spend_secret[i]=0, the value of the corresponding spend_secret[i] will be ignored when the token is later spent, and will neither be enforced nor counted. If use spend_secret[i]=1, the value of corresponding spend_secret[i] may be both enforced and counted when the token is spent. In the preferred embodiments, use_spend_secret[1] (the value corresponding to the first spend_secret) must always be 1, although it would be trivial to create an alternate embodiment that allowed use spend_secret[1] to be 0 or 1. Note also in the preferred embodiments, the trust_secret's are always enforced regardless of the use spend secret values, although it again would be straightforward to create an alternate embodiment that included a corresponding array of use_trust_secret values that functioned like the use spend secret values. Note further that the array of use_spend_secret's may be eliminated with all values assumed to be 1, and the corresponding spend_secret's instead disabled by setting receive_secret[i] to a constant for which second pre-hashes (the spend secrets) are not known. However, such an embodiment would make it more difficult to disable a spend_secret while enabling the corresponding trust_secret, since it would take an extra step to prove to the other parties that the receive_secret has no corresponding spend_secret. This extra step may be accomplished by setting trust_secret=zkhash_X(s) where zkhash_X uses different bases than zkhash_C and the value s is a secret value known only to the generating party, then creating and providing to the other parties a zero knowledge proof that receive_secret=zkhash_D(zkhash_X(s)) where s is a hidden input to the proof.

7. For each output token, the Payees or a designee determines values for required_spend_secrets and required_trust_secrets. If N<Q and the additional receive secret's were set to values with known pre-hashes such as receive_secret=zkhash_D(0), then required_trust_secrets should account for the additional receive_secret's that are known by and can be input into a spend transaction by any party.

8. The Payees or designee chooses a 28 bit destination_number and computes:

destination=zkhash_E(receive_secret[1], receive secret[2], . . . , receive_secret[Q], use_spend_secret[2], . . . , use_spend_secret[Q], required_spend_secrets, required_trust_secrets, destination_number)

The destination_number may be a unique, sequential number for each combination of receive_secret's in order to produce a pseudo-random sequence of unique destination values.

9. The Payees or designee sends the destination value to the Payor using a secure (private and authenticated) channel.

10. For each output token, the Payor chooses an 18 bit payment_number, and computes:

address=zkhash_F(destination, payment_number)

amount_enc=amount̂zkhash_G(destination, payment_number)

commitment=zkhash_H(destination, payment_number, amount)

where ̂ is the bitwise exclusive-or operator. The payment_number may be a unique, sequential number for each destination, in order to produce a pseudo-random sequence of unique address values.

11. The Payor locates or creates one or more output tokens from a prior transaction or transactions to use as the input tokens for the current transaction. In this embodiment, in order to use a token as a transaction input, the Payor must know or obtain at least M1 of the token's spend_secrets where M1 is the required spend secrets value used when the token was created, or M2 of the token's trust secrets where M2 is the required_trust_secrets value used when the token was created. In order to obtain these secrets, the Payor may need to correspond with and negotiate with the holders of the other secrets, who may then use an encrypted channel to send the Payor one or more of the corresponding spend_secrets or trust_secrets when they are satisfied that the Payor should have the authority to spend the token. If the Payor receives a spend_secret, it may compute the corresponding trust_secret=zkhash_C(spend_secret). To construct a valid transaction, the Payor must know or obtain the required secrets for input tokens with sufficient value in total to satisfy the equation:

sum(input token amounts)=>sum(output token amounts)

12. If sum(input token amounts)>sum(output token amounts), then the Payor creates an additional output token that represents the amount of “change” sent to herself or to one or more Payees. This output token uses one or more spend_secret's generated by or acceptable to the Payor, and the amount of this output token is chosen so that the following equation is satisfied:

sum(input token amounts)=sum(output token amounts)

13. For each input token, the Payor chooses boolean values for spend_secrets_valid and trust_secrets_valid. If the Payor knows at least M1 of the token's spend_secret values, the Payor may set spend_secrets_valid to 1, otherwise, the Payor must set this value to 0. If the Payor knows at least M2 of the token's trust_secret values, the Payor may set trust_secrets_valid to 1, otherwise, the Payor must set this value to 0. In order to use the token as a transaction input, either spend_secrets_valid associated with the token must be set to 1, or trust_secrets_valid associated with the token must be set to 1, or both must be set to 1.

14. For each i from 1 to Q of each input token, the Payor chooses a boolean value for secret_valid[i]. If the Payor set spend_secrets_valid associated with the token to 1 and the Payor knows the spend_secret[i] that corresponds to the receive_secret[i] used when the token was created, then the Payor may set secret_valid[i]=1, set spend secret[i] to the known value, and compute and set trust_secret[i]=zkhash_C(spend_secret[i]); otherwise, the Payor must (with exceptions that are not useful in the preferred embodiment) set secret_valid[i]=0. If spend_secrets_valid associated with an input token is 1, the transaction will only be valid (with exceptions that are not useful in the preferred embodiment) if at least M1 spend_secret value are set to correspond to their respective trust_secret values which in turn are set to correspond to their respective receive_secret values, and the respective secret_valid values is set to 1, and the respective use_spend_secret value was set to 1 when the input token was created. If the Payor set trust_secrets_valid associated with the token to 1 and the Payor knows the trust_secret[i] that corresponds to the receive_secret[i] used when a token was created, then the Payor may set secret_valid[i]=1 and set trust_secret[i] to the known value; otherwise, the Payor must set secret_valid[i]=0. If trust_secrets_valid associated with an input token is 1, the transaction will only be valid if at least M2 trust secret values are set to correspond to their respective receive_secret values and the respective secret_valid values are set to 1.

15. The Payor chooses boolean values for enforce_spend_secrets and enforce_trust_secrets. These values are associated with the transaction as a whole. If the spend_secrets_valid values associated with each input token are set to 1 for all of the transaction input tokens, and the Payor wishes to create a transaction that will spend or transfer the input token value as quickly as possible, the Payor sets enforce_spend_secrets for the transaction to 1 and sets enforce_trust_secrets for the transaction to 0. Otherwise, the Payor sets enforce_spend_secrets for the transaction to 0 and sets enforce_trust_secrets for the transaction to 1. Note that in a transaction in which enforce_trust_secrets is set to 1, each of the input tokens must have either spend_secrets_valid or trust_secrets_valid set to 1. In an alternate embodiment, that condition may be changed to only test the value of trust_secrets_valid, instead of either condition. In that case, spend_secrets_valid for each token could be set equal to enforce_spend_secrets, and trust_secrets_valid for each token could be set equal to enforce_trust_secrets, and the proof constraint equations reduced accordingly. This embodiment may be slightly more difficult to use since in a transaction for which the Payor set enforce_spend_secrets to 0 and enforce_trust_secrets to 1, the Payor could not use tokens for which it knew M1 of the token's spend_secrets but did not know M2 of the token's trust_secrets, which might be the case if M2>M1 for that particular token. The Payor could work around this limitation by first creating and submitting a transaction with enforce_trust_secrets set to 1 that transfers the value of the input tokens for which it knows sufficient trust_secret's to an intermediate token with spend_secret's generated by the Payor, and after that first transaction has transferred the input token value as described below, then creating and submitting a second transaction with enforce_spend_secrets set to 1 that transfers the value of the remaining input tokens plus the intermediate token to the intended output tokens.

16. The Payor looks up the root hash of the Merkle tree containing all commitments in all indelible blocks in the blockchain as described in the '0673 application.

17. For each input token, the Payor looks up the token's commitment_number (its location in the Merkle tree) and the hash inputs along the path from the commitment to the Merkle root, as described in the '0673 application.

18. For each input token, the Payor computes

serial_number=zkhash_I(receive_secret[1], commitment, commitment_number)

where receive_secret[1] is the value used when the input token was created.

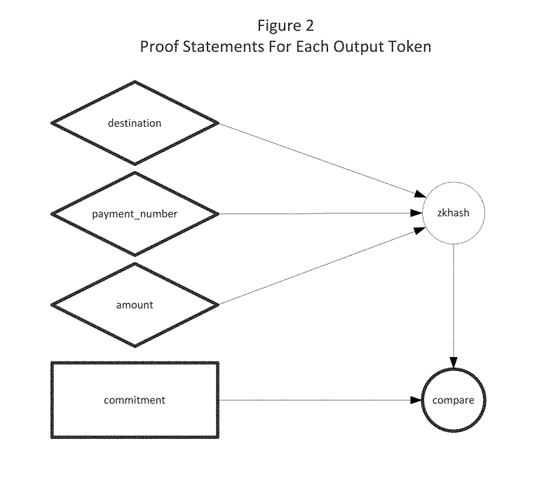

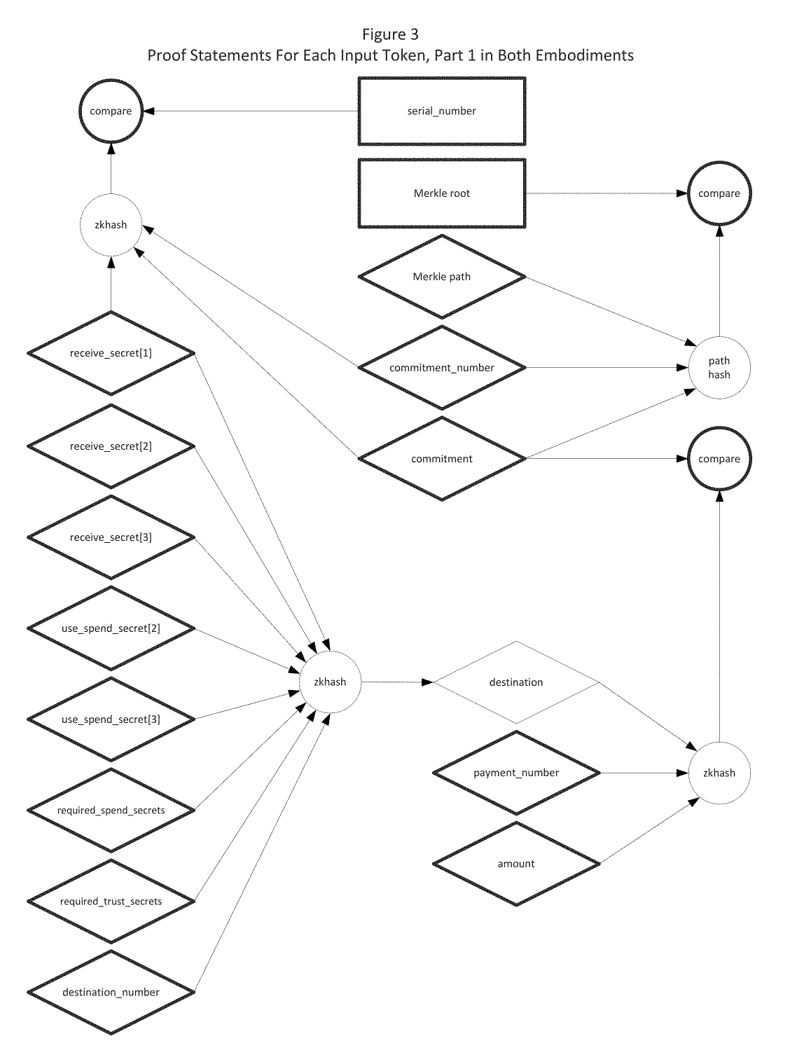

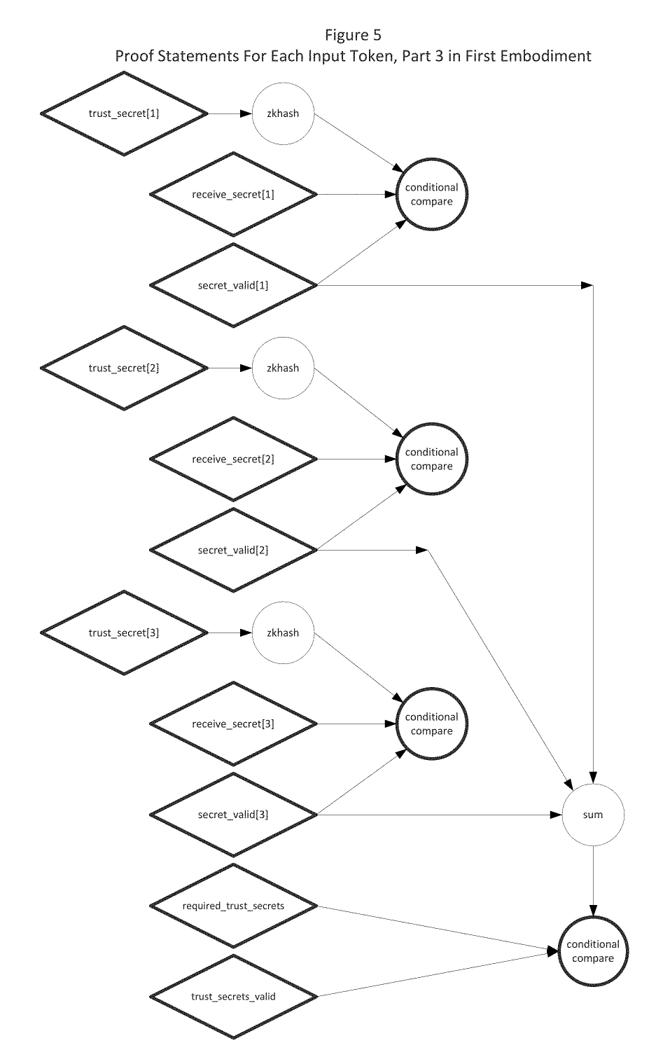

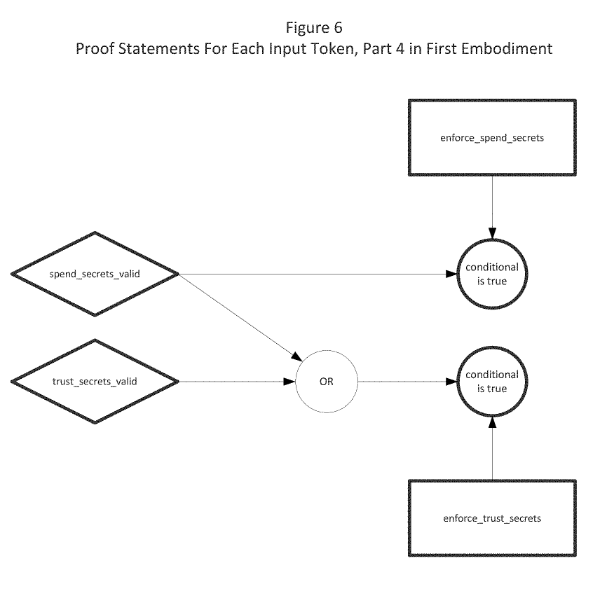

19. The Payor constructs a zero knowledge proof as follows (shown in part in FIGS. 2 through 6):

Public inputs for the entire transaction:
# of input tokens
# of output tokens
Merkle root
enforce_spend_secrets
enforce_trust_secrets

Public inputs for each input token:
serial_number

Hidden inputs for each input token:
spend_secrets_valid
trust_secrets_valid
for i from 1 to Q:
   receive_secret[i]
   spend_secret[i]
   trust_secret[i]
   secret_valid[i]
   use_spend_secret[i]
      where use_spend_secret[1]=1
required_spend_secrets
required_trust_secrets
destination_number
payment_number
amount
the commitment
commitment_number
the hash inputs along the tree path from commitment to Merkle root

Public inputs for each output token:
address
amount_enc
commitment

Hidden inputs for each output token:
destination
payment_number
amount

The zero knowledge proof proves the following constraints are satisfied:

For the transaction as a whole:
all public input values used to create the proof are the same as the public input values used to verify the proof
sum(input token amounts)=sum(output token amounts)

For each input token:

spend_secrets_valid is boolean
trust_secrets_valid is boolean
for each i from 1 to Q:

secret_valid[i] is boolean
use_spend_secret[i] is boolean
spend_secrets_valid * use_spend_secret[i] * secret_valid[i] *

(trust_secret[i] − zkhash_C(spend_secret[i])) = 0

where use_spend_secret[1] = 1

secret_valid[i] * (receive_secret[i] − zkhash_D(trust_secret[i])) =
0

use_spend_secret[1] * secret_valid[1] + ... +

use_spend_secret[Q] * secret_valid[Q] >= spend_secrets_valid *

required_spend_secrets

where use_spend_secret[1] = 1
[Note: the left side of this constraint can also be multiplied

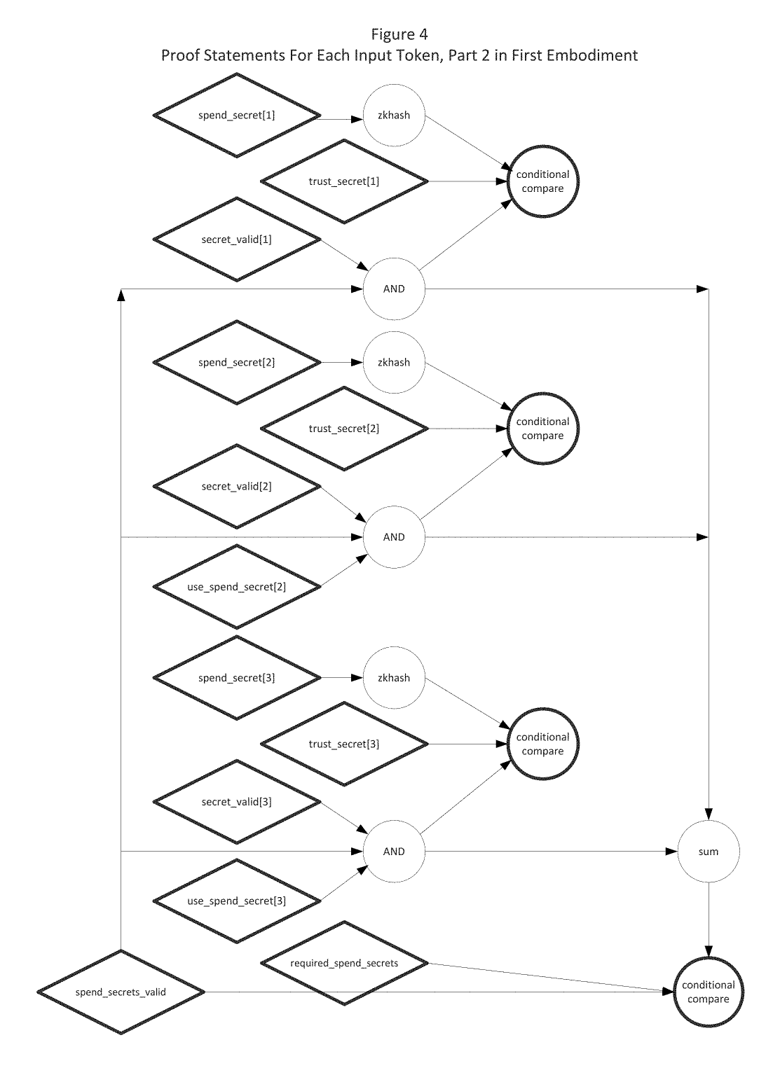

(AND'ed) with spend_secrets_valid, which gives an
equivalent constraint since spend_secrets_valid must be
boolean. This is the form shown in Figure 4.]

secret_valid[1] + ... + secret_valid[Q] >= trust_secrets_valid *

required_trust_secrets

enforce_spend_secrets * (1 − spend_secrets_valid) = 0
enforce_trust_secrets * (1 − spend_secrets_valid) * (1 −
trust_secrets_valid) = 0
commitment = zkhash_H(destination, payment_number, amount)

where destination = zkhash_E(receive_secret[1],
receive_secret[2], ...,

receive_secret[Q], use_spend_secret[2], ...,
use_spend_secret[Q],
required_spend_secrets, required_trust_secrets,
destination_number)

the commitment, commitment_number and Merkle path hash to the
Merkle root
serial_number = zkhash_I(receive_secret[1], commitment,
commitment_number)

For each output token:

address=zkhash_F(destination, payment_number)

amount_enc=amount̂zkhash_G_(destination, payment_number)

commitment=zkhash_H(destination, payment_number, amount)

Constraints for input and output tokens that are allowed by the capacity of the proving key but not used in the transaction are not enforced, i.e., each constraint is multiplied by a conditional variable that reflects whether the input or output token was used in the transaction.

The secret_valid values that the Payor uses in the zero knowledge proof ensure that she knows the required number of spend_secrets or trust_secrets that correspond to the receive_secrets used when each token was created, and the use of spend_secrets_valid and trust_secrets_valid allows the Payor to know either the required number of spend_secrets or the required number of trust_secrets for each input token when enforce_trust_secrets is 1.

20. The Payor constructs a transaction in which are published the public inputs to the zero knowledge proof, the ID of the key used to construct the zero knowledge proof, and the zero knowledge proof itself. Note that since one and only one of the values of enforce_spend_secrets and enforce_trust_secrets for the transaction must be true, only one of these two values could be published and the other computed as the complement (i.e., the boolean NOT).

21. The Payor broadcasts the transaction to the network.

22. Every network node that receives the transaction checks that:
The proof key ID is valid.
The number of transaction input and output tokens is sufficient for the capacity of the proving key.
The values of enforce_spend_secrets and enforce_trust_secrets are both boolean, and at least one of them equals 1.
The zero knowledge proof verifies using the public inputs published in the transaction.
The Merkle root published in the transaction is a valid value for the tree of all commitments.
No serial_number published for a transaction input token has been used as a prior input for this transaction or an earlier transaction in a block that contains this transaction or any block prior to the extent the serial numbers in that block have not expired, except if the earlier transaction had enforce_spend_secrets=0 and has not yet had the effect of transferring the input token value to the output tokens (as described below).

23. If the transaction fails any of these tests, it is discarded. If it passes, the network node considers it to be valid. If the network node is a witness, the witness may place the transaction into a new block, as long as the transaction continues to be valid with respect to all prior transactions in the same block and all prior blocks. The witness may then broadcast the new block across the network.

24. If enforce_spend_secrets=1, the effect of a valid transaction would be to transfer the input token value to the output tokens. In that respect, the present invention functions nearly identically to the system disclosed in the '0673 application, and the input token serial numbers may be entered into a list of spent serial numbers and the output token commitments added to the Merkle tree of valid commitments when the block containing the transaction becomes indelible. If enforce_spend_secrets=0, then the transaction has no immediate effect. However, after a time period determined by the system or as may be requested by a token creator, the transaction may have the effect of transferring the input token value to the output tokens provided that no serial_number published for one of its input tokens has used in a different transaction that has enforce_spend_secrets=1 or has already transferred the input token value to the output tokens. The transfer of value may be automatic following the creation of an unambiguously defined block in the blockchain, such as the first block that contains a timestamp at least T seconds after the timestamp of the block that contains the transaction. In this embodiment, the witnesses would be collectively responsible for the accuracy of the block timestamps, and may refuse to create or build upon a block that has a timestamp value less than the block it builds upon, and may refuse to build on a block that has a timestamp more than a few seconds greater than the witness's local clock time. Alternately, the transfer of value may only occur if the Payor or any other person re-broadcasts the transaction to the network and the transaction is placed into a second block in the blockchain with a timestamp at least T seconds after the timestamp of any existing block in the blockchain that contains an identical transaction. An embodiment may also add an additional public input to the transaction designated by a name such as pre_transfer, and the witnesses may only accept and add the transaction to the blockchain a first time if pre_transfer=1, and may only accept and add the transaction to a block with a timestamp at least T seconds thereafter if pre_transfer=0 and all other public transaction inputs are unchanged. Since the zero knowledge proof requires that all public inputs have not been changed since the proof was created, the Payors would need to create a new proof for the second transaction with pre_transfer=0, thereby confirming their desire to consummate the transfer of value when this transaction with a new proof is created and broadcast to the network. When the token value is considered to be transferred, the input token serial numbers may be entered into a list of spent serial numbers and the output token commitments added to the Merkle tree of valid commitments when the block containing the transaction becomes indelible

25. As described in the '0673 application, the Payor may notify the Payee of payments sent, or the Payee may detect incoming payments by monitoring the addresses associated with the destination values generated by the Payee, and then retrieve the incoming token's properties such as the token's commitment value and amount from the blockchain.

26. If desired, the current invention may also be used in conjunction with the other features of the '0673 application, such as enforce_master_secrets, commitments_published, outvals_public, nonfinancial, no_serialnum and witness_donation. The features of monitor_secret may also be implemented by including it in the first set of secrets, so that monitor_secret=zkhash(trust_secret[1]) and receive_secret[1]=zkhash(monitor secret).

Alternative Embodiment

The above embodiment leads to a single Payor gaining knowledge of the secrets needed to spend a token and therefore gaining complete control over the spending of a token and the destination of the funds. It may be desired instead that the individual holders of the spend_secrets or trust_secrets can approve a specific transaction that spends the token, including the destinations for the funds, without allowing this approval to be used in a transaction that has a different destination for the funds. This is accomplished in this alternative embodiment by having each holder of each input token's spend_secret or trust_secret create a separate zero knowledge proof that approves of the proposed destinations of funds without disclosing their secrets, while an additional zero knowledge proof enforces the properties required of the transaction as a whole. In order to ensure that the common inputs to these proofs have the same values, some values that were hidden inputs in the preferred embodiment must instead be derived from public inputs that are encrypted to maintain privacy in this embodiment. Specifically, in the preferred embodiment, the zero knowledge proof inputs spend_secrets_valid, secret_valid[1], . . . , secret_valid[Q] indicate which secrets have been provided for each input token, and these secrets are then validated and counted in the proof. These inputs are all hidden in order to keep private any information about the number of secrets provided or required. However, in this embodiment, the spend_secrets or trust_secrets are provided and validated in one set of proofs, while they are counted in another proof. In order to ensure the same values are used for spend_secrets_valid, secret_valid[1], . . . , secret_valid[Q] for a given token in each proof, these inputs must be public to allow the verifier to compare the values used. This would normally compromise the privacy of these values, so in order to preserve privacy, the inputs are first encrypted and then the encrypted values are used as public inputs to the proof. The verifier can still compare the encrypted inputs values to ensure the same values are used, but cannot determine the meaning of those values. In the preferred implementation of this alternative embodiment, the encryption is a one-time pad performed by the following sets of equations:

spend_secrets_valid_enc=spend_secrets_valid_xor̂spend_secrets_valid secret_valid_enc[1]=secret_valid_xor[1]̂secret_valid[1]

secret_valid_enc[Q]=secret_valid_xor[Q]̂secret_valid[Q]

The values with a_xor suffix can be referred to as the encryption bits. Maintaining privacy requires that the encryption bits be private, uncorrelated with each other, and effectively impossible to predict from any public values. Maintaining the integrity of the proofs requires that the encryption bits have the same value in each proof in which they are used. To ensure this latter property, the encryption bits must not be subject to manipulation by the person creating the proof. These goals can be accomplished by deriving the encryption bit values from one or more private values that were hashed to compute a value that was published when the token was created, such as the token's commitment. Equivalently, using encryption methods common in prior art, the encryption bit values would be derived from an encryption key, where the encryption key is derived from one or more private values that were hashed to compute a value that was published when the token was created. Those private hash inputs must be effectively random or unpredictable, and must have a sufficient range that the hash cannot be effectively reversed to recover the private values. In addition, the values from which the encryption bits are derived must be hashed either directly or indirectly into at least one value that is published in the transaction in which the token is used as an input, for example, the token's serial_number, that published value or values must be public inputs in each of the proofs in which the encryption bits must have the same values, and the proofs must enforce the relationship between the encryption bits and the published values. The hash that determines the published value or values must have a sufficient range of inputs that it cannot be reversed to recover the encryption bits, the range of the published value or values must be sufficiently large that the person creating the proof cannot effectively find a different set of encryption bit values that satisfy the hashed relationships, and finally, the hash inputs cannot include values that can be manipulated by the person who creates the proof to again effectively find a different set of encryption bit values that satisfy the hashed relationship.

With this in mind, the transaction protocol in the alternative embodiment operates as follows:

1a. A zero knowledge proving system is set up to enforce the constraints given below, possibly with a varying number of input and output tokens as described in Paragraph 1 of the Detailed Description of the Preferred Embodiments. During setup of this zero knowledge proving system, for each input token, Q+1 unique bits of one or more hidden inputs or Q+1 unique bits of a hash of one or more hidden inputs that meet the criteria given above are selected to represent the values of encryption bits spend_secrets_valid_xor and secret_valid_xor[1], . . . , secret_valid_xor[Q]. The preferred implementation of this embodiment sets secret_valid_xor[i] to the i'th bit of zkhash_J(receive_secret[1]) and sets spend_secrets_valid_xor to the Q+1'th bit of zkhash_J(receive_secret[1]), where receive_secret[1] is hashed to compute the commitment which is published when the token is created, and hashed to create the serial number that is published when the token is spent. An alternate implementation may derive the encryption bits from any value or values that satisfy the criteria given in the introduction to this embodiment, which may include extracting the encryption bits from a secret value without first hashing that value, or generating random values for the encryption bits when a token is created and adding these bits to the hash that determines the token's commitment value or to another public value added for that purpose or any other purpose.

2a-10a. The Payor and Payees complete Steps 2 through 10 described in the Detailed Description of the Preferred Embodiments.

11a. The Payor locates or creates one or more output tokens from a prior transaction or transactions that she proposes to use as the input tokens for the current transaction. The total value of the proposed input tokens must satisfy the equation:

sum(input token amounts)=>sum(output token amounts)

12a. If sum(input token amounts)>sum(output token amounts), then the Payor creates an additional proposed output token that represents the amount of “change” sent to herself or to one or more Payees. This output token uses one or more spend_secret's proposed by the Payor, and the amount of this output token is chosen so that the following equation is satisfied:

sum(input token amounts)=sum(output token amounts)

13a. The Payor computes a hash of all of the output token commitments for the proposed transaction:

txout_hash=stdhash(commitment value for transaction output token 1, commitment value for transaction output token 2, . . . )

The txout_hash is defined as part of the protocol such that it may be computed from the public values in the transaction as described below and possibly other publicly known values. The stdhash function used to compute txout_hash may be any cryptographic hash function with a suitable number of output bits such as SHA3.

14a. For each proposed input token, the Payor looks up the token's commitment_number as described in the '0673 application and computes:

serial_number=zkhash_I(receive_secret[1], commitment, commitment_number)

15a. For each j from 1 to Q of each input token, the Payor, or a designee of the Payor such as the person with knowledge of the token's spend_secret[j] or trust_secret[j], chooses boolean values for spend_secrets_valid and secret_valid[j]. If the Payor or designee knows the token's spend_secret[j], he may set spend_secrets_valid to 1, set secret_valid[j] to 1 and compute trust_secret[j]=zkhash_C(spend_secret[j]). If the Payor or designee knows the token's trust_secret[j], he may set spend_secrets_valid to 0 and set secret_valid[j] to 1. If the Payor or designee knows neither secret, he may set spend_secrets_valid to either 1 or 0 and set_secret_valid[j] to 0. The Payor or designee then computes

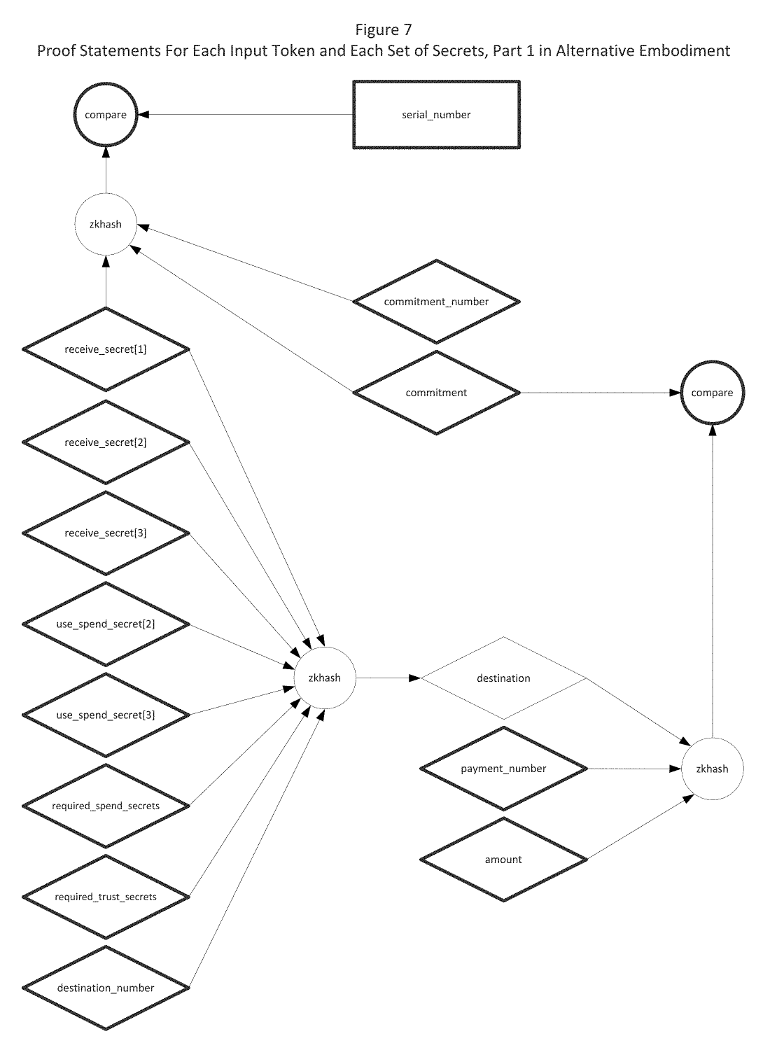

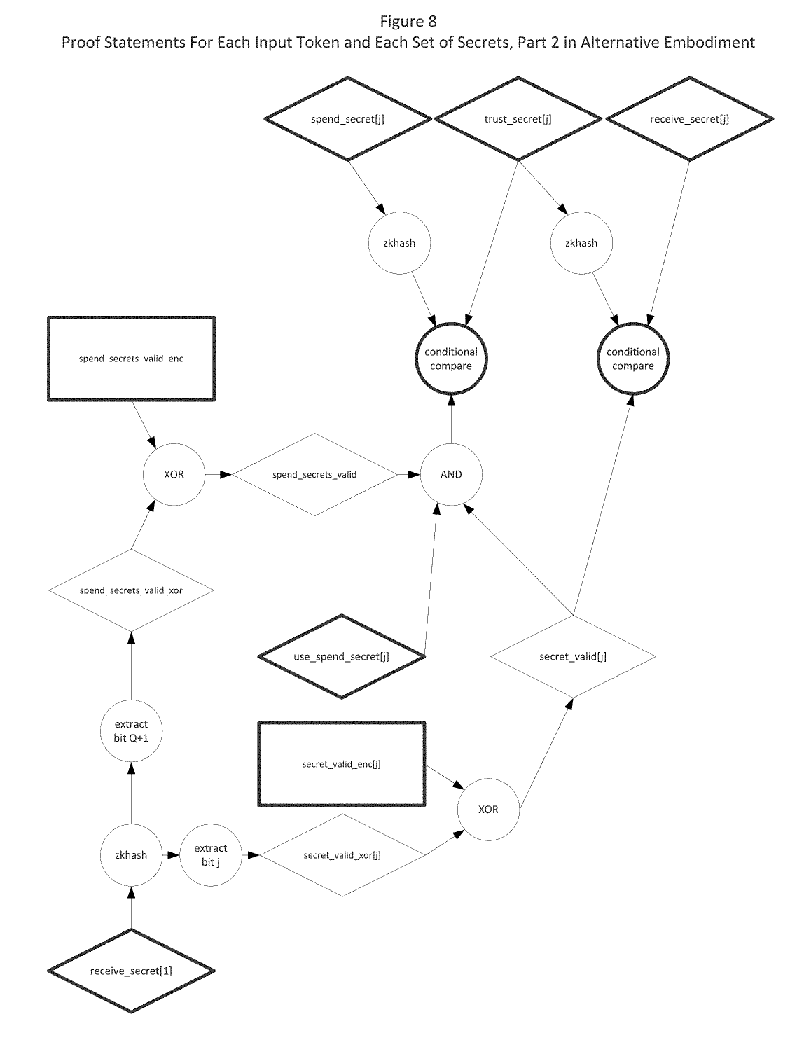

spend_secrets_valid_enc=spend_secrets_valid_xor̂spend_secrets_valid secret_valid_enc[j]=secret_valid_xor[j]̂secret_valid[j]

where spend_secrets_valid_xor and secret_valid_xor[j] are the values that corresponds to the input token as determined in Step 1a above. The Payor or designee then constructs a zero knowledge proof as follows (shown in part in FIGS. 7 and 8):

Public inputs:
txout_hash
serial_number
spend_secrets_valid_enc
secret_valid_enc[j]

Hidden inputs:
for i from 1 to Q:
   receive_secret[i]
   use_spend_secret[i]
      where use_spend_secret[1]=1
spend_secret[j]
trust_secret[j]
required_spend_secrets
required_trust_secrets
destination_number
payment_number
amount
the commitment
commitment_number

The zero knowledge proof proves the following constraints are satisfied:

all public input values used to create the proof are the same as the public
input

values used to verify the proof

for each i from 1 to Q:

use_spend_secret[i] is boolean

spend_secrets_valid * use_spend_secret[j] * secret_valid[j] *

(trust_secret[j] − zkhash_C(spend_secret[j])) = 0

where spend_secrets_valid = spend_secrets_valid_xor \hat{ }

spend_secrets_valid_enc

and spend_secrets_valid_xor = bit Q+1 of
zkhash_J(receive_secret[1])
and secret_valid[j] = secret_valid_xor[j] \hat{ }
secret_valid_enc[j]
and secret_valid_xor[j] = bit j of zkhash_J(receive_secret[1])
and use_spend_secret[1] = 1

secret_valid[j] * (receive_secret[j] − zkhash_D(trust_secret[j])) = 0

where secret_valid[j] = secret_valid_xor[j] \hat{ }
secret_valid_enc[j]
and secret_valid_xor[j] = bit j of zkhash_J(receive_secret[1])

commitment = zkhash_H(destination, payment_number, amount)

where destination = zkhash_E(receive_secret[1],
receive_secret[2], ...,

receive_secret[Q], use_spend_secret[2], ...,
use_spend_secret[Q],
required_spend_secrets, required_trust_secrets,
destination_number)

serial_number = zkhash_I(receive_secret[1], commitment,
commitment_number)

If the zero knowledge proof is constructed by a designee, then the Payor may first send to the designee values such as the receive secret's and other values hashed to compute the commitment values of the proposed transaction output tokens, along with any other information the designee may request. This allows the designee to determine if he approves of the transaction, and if so, compute the txout_hash and construct the zero knowledge proof. Including txout_hash as a public input to the zero knowledge proof ensures that the proof will not verify if it is included with a transaction that alters any of the values associated with the transaction output token commitments, such as the output token amounts, secrets, and number of secrets required to spend the output token. Therefore, by providing the proof, the designee has only given his approval for the specific destination of funds that matches txout_hash. The designee then sends the proof along with the proof's public input values to the Payor. Upon receiving such a proof, the Payor may verify that the proof is valid, and from the public input values and the hidden input values known to the Payor, the Payor may compute:

spend_secrets_valid=spend_secrets_valid_xor̂spend_secrets_valid_enc secret_valid[j]=secret_valid_xor[j]̂secret_valid_enc[j]

16a. In order to complete the proposed transaction, the Payor creates or must obtain a valid proof for each secret j from 1 to Q of each of the transaction input tokens where: (a) all of the proofs for a given input token use the same value for spend_secrets_valid; and (b) if spend_secrets_valid=1 for the proofs associated with a given input token, then at least M1 of the proofs have secret_valid[j] set to 1 and the corresponding value of use_spend_secret[j] was set to 1 when the token was created; or if spend_secrets_valid=0 for the proofs associated with a given input token, then at least M2 of the proofs have secret_valid[j] set to 1. If, for one or more input tokens, the Payor has obtained M2 valid proofs with secret_valid[j] set to 1 but these proofs do not all have spend_secrets_valid set to 0, the Payor may request the respective designees to generate new proofs with spend_secrets_valid set to 0 and otherwise identical inputs, or in the alternate, each time a designee generates a proof with spend_secrets_valid set to 1, it may also generate a proof with spend_secrets_valid set to 0 and send both proofs to the Payor so that the Payor would not need to request a second proof. Note that in an alternative embodiment, the zero knowledge proof could use variables such as spend_secret_valid[j] and trust_secret_valid[j] instead of the variables spend_secrets_valid and secret_valid[j]. In this case, the constraint for enforce_spend_secrets would sum the values of spend_secret_valid[j], while the constraint for enforce_trust_secrets would sum the values of trust_secret_valid[j]. The advantage of this embodiment would be that the Payor would not need to ensure that all proofs for an input token have the same value for spend_secrets_valid, and would therefore not have to potentially request a second proof for one or more secrets. The disadvantage is that the proofs for such an embodiment would require public inputs to encrypt both the spend_secret_valid[j] values and the trust_secret_valid[j] values, almost doubling the number of bits required for this purpose. Since these public inputs would need to be transmitted with the proof and included with the transaction in the blockchain, that would increase the size of the blockchain with no increase in functionality, only a potential increase in convenience for the Payor.

17a. Once the Payor has obtained the required proofs, the Payor chooses boolean values for enforce_spend_secrets and enforce_trust_secrets. If the spend_secrets_valid values associated with each input token are set to 1 for all of the transaction input tokens, and the Payor wishes to create a transaction that will spend or transfer the input token value as quickly as possible, the Payor sets enforce_spend_secrets for the transaction to 1 and sets enforce_trust_secrets for the transaction to 0. Otherwise, the Payor sets enforce_spend_secrets for the transaction to 0 and sets enforce_trust_secrets for the transaction to 1.

18a. The Payor looks up the root hash of the Merkle tree containing all commitments in all indelible blocks in the blockchain and the hash inputs along the path from each input token commitment to the Merkle root, as described in the '0673 application.

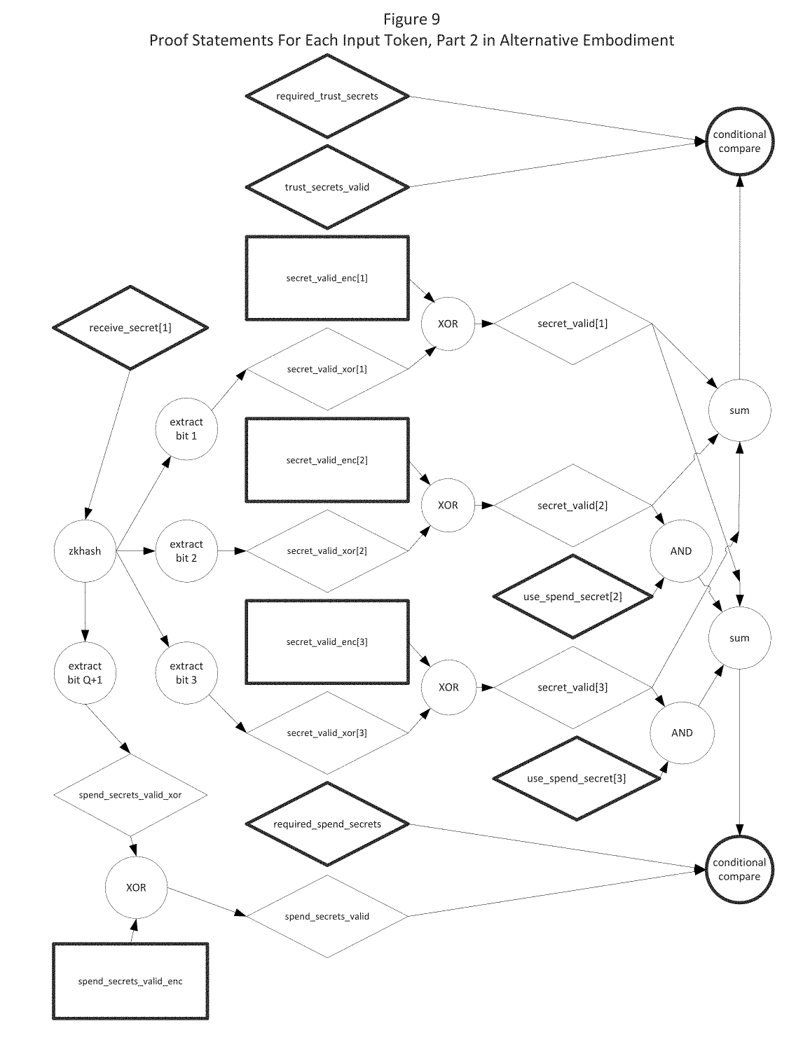

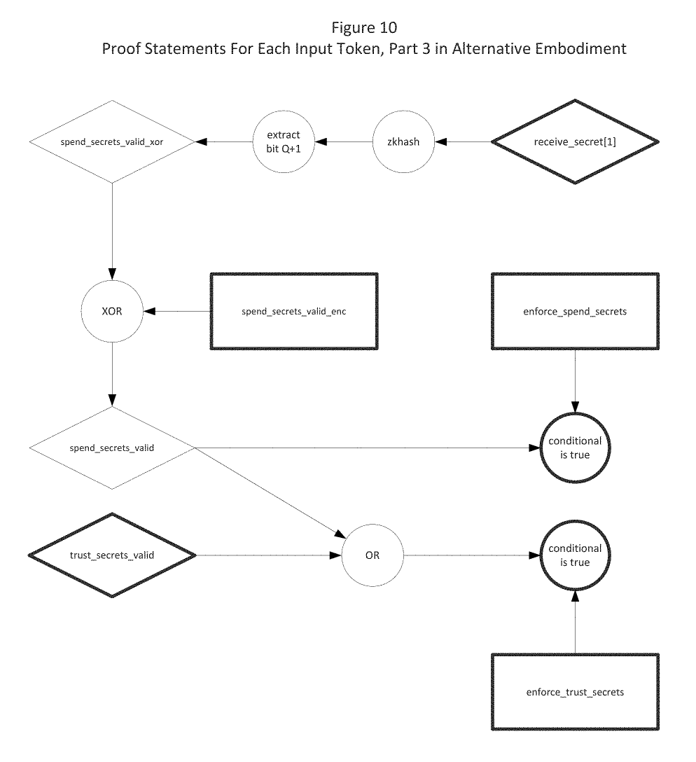

19a. The Payor then constructs a zero knowledge proof as follows (shown in part in FIGS. 2, 3, 9 and 10):

Public inputs for the entire transaction:
# of input tokens
# of output tokens
Merkle root
enforce_spend_secrets
enforce_trust_secrets
Public inputs for each input token:
serial_number which must be the same value used in the proofs in Step 15a above
spend_secrets_valid_enc which must be the same value used in the proofs in Step 15a above
for i from 1 to Q:
   secret_valid_enc[i] which must be the same value used in the proof in Step 15a above

Hidden inputs for each input token:
trust_secrets_valid
for i from 1 to Q:
   receive_secret[i]
   use_spend_secret[i]
      where use_spend_secret[1]=1
required_spend_secrets
required_trust_secrets
destination_number
payment_number
amount
the commitment
commitment_number
the hash inputs along the tree path from commitment to Merkle root

Public inputs for each output token:
address
amount_enc
commitment

Hidden inputs for each output token:
destination
payment_number
amount

The zero knowledge proof proves the following constraints are satisfied:

For the transaction as a whole:
all public input values used to create the proof are the same as the public input values used to verify the proof
sum(input token amounts)=sum(output token amounts)

For each input token:

trust_secrets_valid is boolean
for each i from 1 to Q:

use_spend_secret[i] is boolean

use_spend_secret[1] * secret_valid[1] + ... +

use_spend_secret[Q] * secret_valid[Q] >=
spend_secrets_valid *
required_spend_secrets

where spend_secrets_valid = spend_secrets_valid_xor \hat{ }

spend_secrets_valid_enc

and spend_secrets_valid_xor = bit Q+1 of
zkhash_J(receive_secret[1])
and secret_valid[i] = secret_valid_xor[i] \hat{ } secret_valid_enc[i]
and secret_valid_xor[i] = bit i of zkhash_J(receive_secret[1])
and use_spend_secret[l] = 1

secret_valid[l] + ... + secret_valid[Q] >= trust_secrets_valid *

required_trust_secrets

where secret_valid[i] = secret_valid_xor[i] \hat{ } secret_valid_enc[i]
and secret_valid_xor[i] = bit i of zkhash_J(receive_secret[1])

enforce_spend_secrets * (1 − spend_secrets_valid) = 0

where spend_secrets_valid = spend_secrets_valid_xor \hat{ }

spend_secrets_valid_enc

and spend_secrets_valid_xor = bit Q+1 of
zkhash_J(receive_secret[1])

enforce_trust_secrets * (1 − spend_secrets_valid) * (1 −
trust_secrets_valid) = 0

where spend_secrets_valid = spend_secrets_valid_xor \hat{ }

spend_secrets_valid_enc

and spend_secrets_valid_xor = bit Q+1 of
zkhash_J(receive_secret[1])

commitment = zkhash_H(destination, payment_number, amount)

where destination = zkhash_E(receive_secret[1],
receive_secret[2], ...,

receive_secret[Q], use_spend_secret[2], ...,
use_spend_secret[Q],
required_spend_secrets, required_trust_secrets,
destination_number)

the commitment, commitment_number and Merkle path hash to the
Merkle root
serial_number = zkhash_I(receive_secret[1], commitment,
commitment_number)

For each output token:

address=zkhash_F(destination, payment_number)

amount_enc=amount̂zkhash_G(destination, payment_number)

commitment=zkhash_H(destination, payment_number, amount)

Constraints for input and output tokens that are allowed by the capacity of the proving key but not used in the transaction are not enforced, i.e., each constraint is multiplied by a conditional variable that reflects whether the input or output was used in the transaction.

Because the spend_secrets_valid_enc and secret_valid_enc values are public inputs, any party can verify that the same values were used when creating the proofs in Step 15a and in this step, which ensures that the proof in this step is counting and enforcing the required number of spend_secrets or trust_secrets, even though the secrets themselves were provided in the proofs created in Step 15a rather than this proof.

20a. The Payor constructs a transaction in which are published: (a) the public inputs to all of the zero knowledge proofs except txout_hash; (b) the ID of the keys used to construct the zero knowledge proofs; and (c) the zero knowledge proofs themselves. The public inputs that must have the same value in more than one proof (as described above) may be published only once and that value used as the public input for all proofs when checking the validity of the transaction.

21a. The Payor broadcasts the transaction to the network.

22a. Every network node that receives the transaction checks that:
The proof key ID is valid.
The number of transaction input and output tokens is sufficient for the capacity of the proving key.
Public inputs that are required to have the same value in more than one proof (as described above) do in fact have the same value.
For each input token, spend_secrets_valid_enc is boolean.
For each secret i from 1 to Q of each input token, secret_valid_enc[i] is boolean.
The values of enforce_spend_secrets and enforce_trust_secrets are both boolean, and at least one of them equals 1.
The zero knowledge proofs verify using the public inputs published in the transaction and the value of txout_hash computed from those public inputs.
The Merkle root published in the transaction is a valid value for the tree of all commitments.
No serial_number published for a transaction input token has been used as a prior input for this transaction or an earlier transaction in a block that contains this transaction or any block prior to the extent the serial numbers in that block have not expired, except if the earlier transaction had enforce_spend_secrets=0 and has not yet had the effect of transferring the input token value to the output tokens (as described in the Detailed Description of the Preferred Embodiments and re-adopted below).

23a-26a. Paragraphs 23 through 26 of the Detailed Description of the Preferred Embodiments also apply to this embodiment. In addition, if monitor_secret is included in the implementation, the embodiment may derive the encryption bits from the hash of the monitor_secret in order to keep their values private from parties who know receive_secret[1] but do not know monitor_secret.

27a. The total number of proofs P included with each transaction is n*Q+1 where n is the number of input tokens. Instead of including P proofs with each transaction, the Payor may combine the individual proofs into a more succinct (i.e., requiring fewer bytes to represent) proof using a multi-party computation or multi-party zero knowledge proving system described in prior art or that may be invented in the future. This more succinct proof would prove that all the constraints of the individual proofs are satisfied, without any of the parties revealing their hidden inputs to each other or to the public.

Scope of Invention

While the present invention has been described with reference to exemplary embodiments, it will be understood by those of ordinary skill in the art that various changes may be made and equivalents may be substituted for elements thereof without departing from the scope of the invention. In addition, many modifications may be made to adapt a particular application to the teachings of the invention without departing from the scope thereof. Therefore, it is intended that the invention not be limited to the particular embodiments disclosed, but that the invention will include all embodiments falling within the scope of the allowed claims.

What is claimed is:

1. A method of computing zero knowledge or privacy-preserving proofs in which two or more provers each produce one or more proofs, and in which two or more of said proofs produced by different provers include a value that must be the same in all said proofs and that is known to the respective provers but is to otherwise be kept private, the method comprising: using said private value as a hidden input to each said proof; encrypting said private value and using said encrypted value as a public input to each said proof, where each said proof constrains said hidden input to equal the encrypted value of said encrypted public input.

2. The method of claim 1, where the encryption key for said encryption is derived from one or more values that comprise all or part of the pre-hash values of one or more other public inputs that are common to all said proofs, and where each said proof also constrains said other public inputs to equal the hash of said pre-hash values.

3. The method of claim 1, in which said proofs are used for cryptographic transactions.

4. The method of claim 2, in which said proofs are used for cryptographic transactions.
